(19) United States
(12) Patent Application Publication
(10) Pub. No.: US 2020/0172840 A1
(43) Pub. Date: Jun. 4, 2020

(54) METHOD FOR FERMENTING A JUICE CONTAINING SUGARS AND APPARATUS FOR IMPLEMENTING SAME

(71) Applicant: AB7 Industries S.A., Deyme (FR)

(72) Inventors: René CHELLE, Deyme (FR); Francois DAVAUX, Lavaur (FR)

(21) Appl. No.: 16/638,257

(22) PCT Filed: Aug. 2, 2018
(86) PCT No.: PCT/FR2018/000198

§ 371 Date: Feb. 11, 2020

(30) Foreign Application Priority Data
Aug. 11, 2017 (FR) 1770846

(51) Int. Cl. C12C 11/07; C12C 11/09; C12G 1/02; C12G 3/025

(52) U.S. Cl. CPC C12C 11/075; C12C 11/09; C12G 2200/05; C12G 3/025; C12G 1/0203

(57) ABSTRACT

The method comprises a step for culturing microorganisms and a fermentation step. The apparatus comprises two compartments (5 6), one for each step of the method, and the two are separated by a filtering barrier (8), which allows circulation of the medium to be fermented.

The present invention relates to the production by fermentation of beverages using nutritive liquid media containing sugars and, specifically to the field of the production of an alcoholic beverage such as wine, fermented fruit juice or beer.

French patent 2887257 has already proposed a method for the preparation of a fermented beverage from fruit juice; in this patent it is essentially sought to produce a beverage with a low percentage of alcohol using natural fruit juice, for which the initial rate of sugar can potentially result in a beverage with a higher alcohol content. This method uses only biologic culturing methods and yeast fermentation: it is based on fermentation mechanisms identical to those that are commonly used for the production of wines and that make it possible to obtain a beverage with organoleptic qualities that are attractive to consumers. This method consists, on one hand of supplying an anaerobic culture reactor containing yeast in multiplication phase with a first fraction of fruit juice, and on the other hand, of supplying and anaerobic fermentation reactor with the medium loaded with yeast obtained at the step cited above and with a second fraction of fruit juice, in order to obtain a must, and finally, of filtering the must in order to separate the yeast and the fermented beverage thus obtained. This patent also discloses a device for the implementation of the above cited method; this device comprises a first reactor for the aerobic culturing of yeast, a second reactor for anaerobic fermentation by means of said yeast, these reactors being equipped with means for the introduction of a determined fraction of fruit juice, with a filtration unit for the product of fermentation and with means for the transfer between the reactors and the filtration unit in order to obtain, by batch, the desired product.

The problem with this state of the art is that it requires the implementation of costly equipment and does not make continuous production of the final product possible. The scope of the method according to this state of the art includes, clearly, the production of wines. In the case of wine, grape juice is traditionally subjected to alcoholic fermentation and to a malo-lactic fermentation: these fermentations are performed on the must in unstirred tanks, which requires a relatively long time, which is not conducive to obtaining high production.

We therefore propose to improve yield by using immobilized microorganisms, and no longer free organisms in the liquid medium in which the fermentations are conducted, but this operational mode is not yet perfected (Z. Genisheva, J. A. Teixeira and J. M. Oliveira, “Trends in Food Science and Technology,” 40, (2014), pp. 33-47). It is in particular known that the mode of immobilization of the microorganisms can act on the speed of the fermentation reaction, on the ease of separation of the microorganisms in relation to the circulating liquid medium and on the ability to recover microorganisms after the end of the fermentation (P. Strehaiano, F. Centeno—IFV Midi-Pyrenees “Rencontres techniques microorganismes et gestion thermique,” (Dec. 18, 2008), pp. 26-27). Among the difficulties that arise, certain of them are related to the activity of the microorganisms implemented for the fermentations, others originate with the means for maintaining the microorganisms in place, which are immobilized on the media, and finally others originate with the internal structure of the reactors where the immobilized microorganisms are placed.

In this state of the art (European Patent Application 0046613), it is stated that the immobilization of microorganisms by adhesion to a solid medium, in relation to other processes, presents the advantage of maintaining a direct contact between the microbial population and the liquid medium and, as a result, of reducing limitations, by so-called “fusional” phenomena, of the transfer of nutritive substances or of substances produced by the microorganisms; it has been stated that a high proportion of adhering microorganisms conserve the ability to conduct enzymatic reactions and to reproduce. Using this same document, the person skilled in the art knows that the media for usable adhering microorganisms can be very diverse mineral or organic materials.

The goal of this invention is to reduce the time for obtaining a fermented product using a fruit juice and, specifically, wine, using a must, by the use of microorganisms fixed on a solid medium, the overall apparatus implemented remaining at a reduced cost despite the significant increase in productivity due to the rapid execution of the necessary fermentations. In the case of processing of a grape must in order to obtain a must, the method can be used for alcoholic fermentation and malo-lactic fermentation. The method according to the invention results in continuous production, which is especially advantageous in the operational area.

The present invention has, as a result, as its first subject, a method for fermentation of a supply flow of nutritive liquid medium using yeast or bacteria, with this method comprising two steps, in the first of which an aerobic multiplication of said microorganisms is ensured using the supply flow with which they are put into contact, and in the second of which, the microorganisms thus multiplied during the first step are used to ensure the fermentation of said nutritive medium and to provide, at output, a flow of fermented nutritive medium, a method for which the continuous implementation consists of ensuring, in the first step, the fixing by adhesion of at least a part of the microorganisms, on at least a fraction of a solid medium, in order to constitute, with the solid medium(s) thus loaded, at least one filtering barrier interposed between the supply of the nutritive medium and the output of the fermented nutritive medium, characterized in that, in order to constitute the filtering barrier, the nutritive medium is passed on said solid mediums loaded with microorganisms grouped inside one or more housings, in order to supply, at peripheral output, the fermented nutritive medium.

According to a first embodiment of the method according to the invention, the microorganisms are yeast from alcoholic fermentation.

According to a second embodiment of the method according to the invention, the microorganisms are bacteria from malo-lactic fermentation. In this case, the nutritive liquid medium is an at least partially fermented nutritive medium and the aeration is low.

According to an embodiment of the method according to the invention, in the first step, the fixing of the microorganisms is effected on a plurality of fractions of solid media implemented, during said first step, into the supply flow of the nutritive medium.

In an embodiment of the variant defined above, fractional solid media are made of wood, metal, sintered metal, a porous or non-porous plastic material, porous organic material, porous mineral material, particularly a porous ceramic material, or any other porous material compatible with the liquid to be fermented.

In another embodiment, solid media are chosen constituting wires, steel wires, stainless or not, slides, groups of slides and/or of wires, metallic helicoids in cylindrical or tronconical shape, or metallic grids.

In an embodiment of the method according to the invention, in order to constitute a filtering barrier with the fractional media implemented in the supply flow of the nutritive medium during the first step, said supply flow is passed through a fixed tray which retains the fractional media in order to form a bed enclosing a large part of the microorganisms multiplied during the first step.

In an embodiment of the method according to the invention, in order to constitute a filtering barrier with the fractional media implemented in the supply flow of the nutritive medium during the first step, said supply flow is passed vertically through a stack of horizontal arranged parallel to each other, the fractional media remaining caught in the spaces between the grids.

In an embodiment of the method according to the invention, the filtering barrier is constituted around a nutritive medium supply zone, in a cylindrical shape, for which the output is arranged peripherally, said filtering barrier being constituted by a cylindrical ring of fractional media held externally by a sleeve, which constitutes the housing and which allows the liquid flow of the nutritive medium to pass in order to constitute the output of the fermented nutritive medium.

In an embodiment of the method according to the invention, the housing is a plurality of cartridges, which can be detachable, enclosing the fractional media, in a substantially tubular shape installed on a tray, impermeable to the liquid, overflowing in relation to the horizontal plane of said tray, on the horizontal plane of said tray, on one hand and, of which the lateral wall is of a perforated material or of metallic grids, on the other hand The height of the overflow of the upper part of each cartridge corresponds substantially to the thickness of the bed of fractional solid media on the tray which ensures the execution of a first fermentation. In this case, the flow of the partially fermented nutritive medium coming from the bed spills into each one of the cartridges in order to undergo the second fermentation there.

The invention also has as a subject a device for the implementation of the method defined above, a device which comprises two compartments, wherein one of the compartments is equipped with an output for filling for the extraction of a liquid constituted by a nutritive medium, which has already undergone the desired fermentation, the other compartment being equipped with a supply for the introduction of said nutritive medium, unfermented or weakly fermented, and with a transit output toward first compartment, with a filtering barrier being arranged between the two compartments the liquid of one of the compartments containing, during operation, at least one solid medium on which microorganisms are adhered, which were introduced into said first compartment during the start-up phase, characterized in that the filtering barrier is constituted of said solid media which are grouped inside one or more housings, possibly detachable, in order to provide at output, peripherally, the fermented nutritive medium.

In a variant of the device according to the invention, during the start-up phase, the microorganisms are introduced into the first compartment by recycling a fraction of nutritive medium which has already undergone, at least partially, the desired fermentation.

In a variant of the device according to the invention, the filtering barrier is a bed constituted of a layer of fractional mediums bearing adhering microorganisms, with this bed being supported by a perforated tray, or a fixed grid placed in the passage between the two compartments.

In a variant of the device according to the invention, the two compartments are arranged to the right of each other, the transit of the flow of nutritive medium being conducted by gravity. In such case, the housing can be a plurality of cartridges, enclosing the fractional media, in a substantially tubular shape placed on a tray, impermeable to the liquid, placed in the passage between the two compartments, a cartridge of which the upper part, impermeable to the liquid, overflows in relation to the horizontal plane of said tray, on the other hand, and of which the lateral wall is of a perforated material or of metallic grids, on the other hand The height of the overflow of the upper part of each cartridge substantially corresponds to the thickness of the bed of fractional solid mediums.

In a variant, the device according to the invention comprises two units of the same structure, for which the filling outputs are arranged in a series in order to supply the input of a storage tank of fermented product, one of the units providing fermentation by means of the yeast, and the other by means of the bacteria.

In a variant of the device according to the invention, the bed of fractional media is fluidized by the nutritive medium or by air, especially in the case of yeast.

In a variant of the device according to the invention, the filtering barrier is a cluster in a cylindrical ring of fractional media retained around a cylindrical supply volume of the nutritive medium, by a sleeve, which constitutes the housing, and which allows the passage of the output flow of the fermented nutritive medium.

In a variant of the device according to the invention, the second compartment is a closed volume defined by a fabric or a permeable perforated material and supplied by a conduit which brings to it the microorganisms, the oxygenated gas and the nutritive liquid medium, partially fermented or not, this second compartment enclosing the fractional media onto which the microorganisms adhere, the first compartment being an enclosure inside which is arranged said second compartment, said enclosure being filled by the fermented nutritive medium produced then ejected from the second compartment by the circulation liquid that crosses it, in order to supply an external storage tank.

We can choose as the perforated material a plastic or metallic material for which the entirety in its overall structure is permeable to the nutritive liquid medium. Said material is presented in the form of a film or membrane, flexible or not, and of low thickness.

In a variant of the device according to the invention, the enclosure, which constitutes the first compartment and is of one piece with the second compartment and with its conduit in order to be able to be placed in a storage tank as a monobloc assembly constituting a cartridge.

In a variant of the device according to the invention, the conduit of the second compartment is equipped with piping which, when its opening is inserted into the tank, to which it is attached, makes possible a partial recirculation of the liquid contained in said tank.

In a variant of the device according to the invention, the second compartment is a component containing at least one metallic grid, of which the wires form media for the culturing of the microorganisms.

In a variant of the device according to the invention, the component comprises a plurality of grids, of which the wires are close to each other in order to improve the efficiency of the fermentation said grids being planes and parallel, or cylindrically rolled, wherein the component is equipped with end sleeves, which hold the grids between each other and which ensure the input and output of the nutritive liquid medium.

In a variant of the device according to the invention, the liquid nutritive medium is a grape must and the obtained nutritive liquid medium is a wine.

In a variant of the device according to the invention, the nutritive liquid medium is a fruit juice and the device produces a fermented juice.

In a variant of the device according to the invention, the fermented nutritive medium obtained by the implementation of the device is a beer.

In order to better understand the invention, we will disclose below several examples of embodiment and of implementation represented on the annexed drawing. On this drawing:

FIG. 1 is a schematic representation, in axial section, of a first means of embodiment of a device according to the invention making it possible to ensure the alcoholic fermentation of a grape must, the extraction of the fermentation product being a wine.

FIG. 2A is a schematic representation, in axial section, of a second means of embodiment of a device according to the invention with the same function as that of FIG. 1, in its version for autonomous operation;

FIG. 2B represents the device of FIG. 2A when it is connected directly to a vindication tank, wherein this device constitutes a detachable cartridge which can be connected to one tank or another;

FIGS. 3 to 7 are schematic representation of different embodiments of media for yeast or bacteria, capable of being inserted into the devices according to FIGS. 1, 2A or 2B;

FIG. 8 is a schematic representation of an alcoholic fermentation reactor and a malo-lactic fermentation reactor with a wine storage tank.

Referring to FIG. 1, we see that the reactor according to the invention has the shape of a cylindrical tank designated by 1 in its assembly, wherein the tank 1 comprises in the upper portion, a conduit 2, by which an air flow is introduced by means of a classic device, for which the details are not shown (the arrow FO symbolizes the air flow). At the base of the tank 1, is located a conduit 3, which makes it possible to introduce, into the tank 1, according to the arrow F1, a flow of must which constitutes the nutritive liquid medium in order to ensure the filling of the tank. In the neighboring area of the upper portion of the tank 1, an extraction opening 4 has been specified which makes it possible, according to the arrow F2, to output the fermented liquid product which is desired. The tank 1 is separated into two compartments 5 and 6 by a perforated plate 7 parallel to the bases of the cylindrical tank 1. The perforated plate 7 is made of stainless steel and fixed to the lateral walls of the tank 1; it is covered by a bed, of a certain thickness, constituted by small wooden plates or chips onto which adhere the yeast that will be used in order to conduct the alcoholic fermentation on the must processed by the reactor. The must introduced according to arrow F1 crossed the perforated plate 7, such that the bed of wooden strips, designated by 8 in its assembly, constitutes a fluidized bed due to the ascending movement of the liquid introduced according to the arrow F1. The nature of the wood strips 10 is such that it can be used to improve the organoleptic quantities of the obtained product of fermentation.

The status of the fluidized bed 8, which has just been described, is that which exists in the tank 1 as part of its permanent conditions; but, in the start-up phase, a load of wood strips 10 has been placed in compartment 5, by means of opening 9, intended to constitute the bed 8. The wood strips thus introduced have been represented on the drawing, falling by means of gravity. The wood strips thus loaded in the reactor have been, by prior processing, covered with yeast which adhered to them, wherein this yeast is that which will make alcoholic fermentation of the must introduced into the tank possible. In a variant, it being a given that the must contains, in its natural state, alcoholic fermentation yeast, a prior adhesion of the yeast to the wood strips can be carried out, but adding more or less commercial yeast through opening 9, so that the adhesion of the yeast to the wood strips 10 is carried out in the compartment 5.

In order to regulate, in compartment 5, the alcoholic fermentation, a by-pass circulation by means of a tube 11 can be implemented, which connects the compartment 6 and the compartment 5 in order to avoid passage through the fluidized bed 8, the flow of this conduit 11 being regulated by a pump 12.

When the start-up phase has ended and the degree of fermentation desired has been reached in compartment 6, the degree of fermentation in compartment 6 remains constant since the yeast of the fluidized bed 8 multiplies during the process due to the oxygenation due to the introduction of air according to arrow F0 and the supply according to arrow F1 undergoes alcoholic fermentation by increase of the yeast in compartment 5. The ability to modify the quantity of by-pass by means of pump 12 makes it possible to specify, if desired, a production of yeast to be extracted from the filling flow according to F2. The person skilled in the art will know the quantity of air which must be introduced into the multiplication of the microorganisms, without altering, by oxidation, the desired quality of the final product.

It is clear that in its permanent regime, compartment 5 comprises practically no strips 10 which, after start-up, have all sedimented in bed 8. The fact that the yeast is adhered to the fractional media which constitute the wood strips, is favorable to their fermentation efficiency. It is clear that, in the start-up phase of the reactor, which has just been disclosed, a phase which is essentially used to culture the yeast, a molasses solution can be used as the nutritive medium which will later be evacuated from the reactor by conduit 3.

FIG. 2A represents, in schematic axial section, a second means of embodiment of the reactor according to the invention. This reactor is presented in the general form of a cylinder 100 which is filled with a nutritive medium 101, constituted by a grape must. According to the axis of the cylinder 100, a piping 102 has been arranged by which an air flow can be made to enter the cylinder 100, according to arrow F′0, on one hand and, on the other hand, according to arrow F′1, a flow of nutritive medium which is to be subject to a fermentation step; this flow of nutritive medium is pumped by means of the pump 112 inside the cylinder 100.

A compartment is arranged around the conduit 102, in the cylinder 100, which is defined by a cylindrical fabric sleeve, inside of which buffers made of metallic strips have been amassed, wherein this filling is sufficiently snug such that the liquid flow channeled by the conduit 102 has a large area of contact with the filling; it is arranged such that the output of the conduit 102 is situated principally toward the bottom of the cylinder 100 and that the flow in the sleeve is ascending, the ends of the sleeve being hermetically sealed; the flow of the nutritive medium 101 is evacuated radially through the metallic buffer which, as a whole, is designated by 108.

When the flow F′ contains yeast, this yeast adheres to the metal constituting the buffer 108 before the flow of liquid exits from the sleeve 107 to go into the cylinder 100, thereby ensuring the output of the nutritive medium 101 thus processed by the upper part of the cylinder 100, with this output not represented on FIG. 2A. The reactor of FIG. 2A can be used in isolation like that of FIG. 1, but it can also (see FIG. 2B) be used in combination with a tank, which contains a wine having already been subject to an alcoholic fermentation using an initial must. In this case, the wine is placed in a tank 120, which comprises a manhole in its upper part, the hole being closed by a cover 121. The cover 121 is assembled on the device of FIG. 2A, such that the cylinder 100 is plunged into the tank 120 and the free end of the conduit 102 also plunges into the liquid contained in the tank 120. The cylinder 100 comprises a pump 112 at its base, the output of which ejects the liquid, according to arrow F′2, contained in the cylinder 100 inside the tank 120.

In this use, the sub-assembly of FIG. 2A is therefore mobile and can be used as a detachable cartridge, on different storage tanks 120. An installation constituted of two reactors 131 and 132, respectively for alcoholic and malo-lactic fermentations, can also be specified; each of the reactors is like that in FIG. 2A and the outputs are connected in series to supply a storage tank 130. When it is estimated that the yeast has reached maximum multiplication in the reactor 131, the temperature is set to about 15° C. in order to activate the establishment of alcoholic fermentation; once this has finished, the alcoholic beverage is extracted so that it can be introduced into the malo-lactic fermentation 132 reactor; after which, the wine is sent to a storage tank 130. This means of embodiment is represented in FIG. 8.

Below, different means of embodiment of media in metallic materials capable of being used for the implementation of the method according to the invention will be disclosed, specifically in the means of embodiment previously disclosed for the device according to the invention.

In FIG. 3, a perspective representation of a textile made of stainless-steel threads is provided; this textile is rolled around itself in order to constitute a three-dimensional shape, substantially tubular, designated by 200 as a whole. The steel thread that constitutes this textile can have a diameter of up to about 1 mm; the adhesion of the microorganisms is improved by striating the surface of the thread. The hollow space according to the rolled axis makes it possible to place a perforated tube (not represented) to ensure the aeration of the microorganisms fixed on the thread.

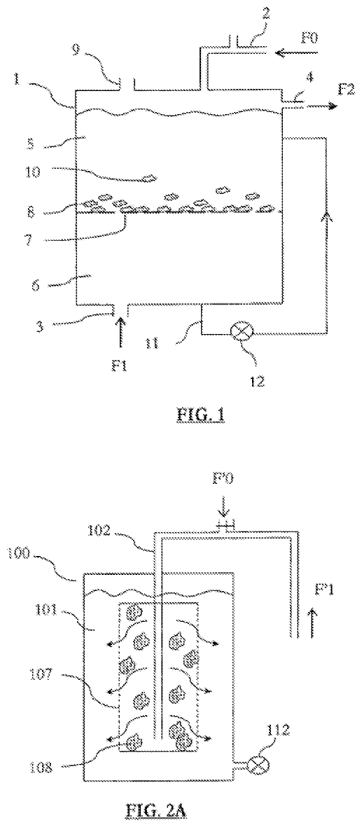

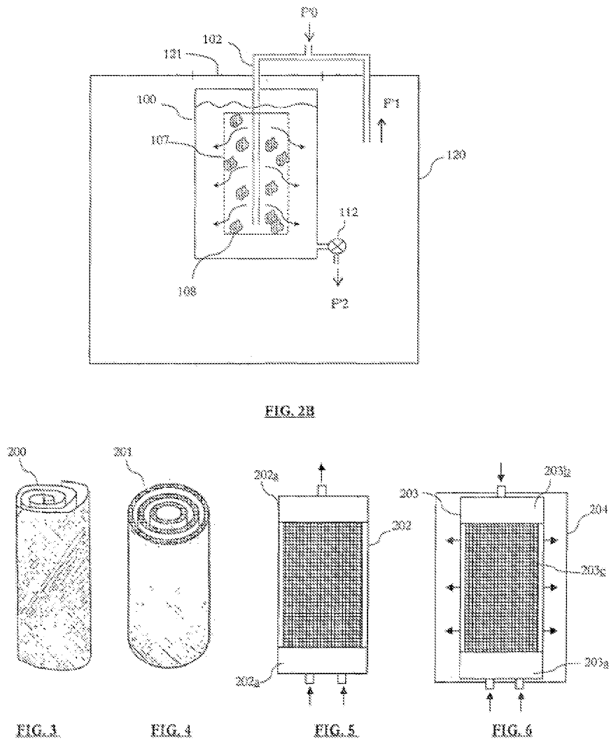

FIG. 4 is a representation, in perspective, of another textile medium of stainless-steel threads; this medium 201 is constituted by several co-axial, cylindrical rollings, of which each layer is spaced from the neighboring layers by a distance of up to 5 mm. The spacing between the layers provides appropriate air circulation, which is necessary for the multiplication of the microorganisms, in particular yeast.

FIG. 5 represents, in perspective, a cylindrical cartridge 202, intended to be placed vertically in a reactor according to the invention; the supply for this cartridge is performed from below to above, with the nutritive medium being sent by two low inputs and the output being performed at the upper part of the cartridge. The inside of the cartridge 202 contains fractional solid media 202b, which are required for fermentation; the cartridge is defined, at the upper part and the lower part by stoppers 202a which maintain the particular media arranged in the interior.

FIG. 6 represents a cartridge 203 like that of FIG. 5, placed inside a vinification tank 204. The structure of this cartridge comprises, at its lower part, a stopper 203a, which receives the nutritive medium to be fermented, at its upper part, a stopper 203b, which also receives a supply and, between the two stoppers, a lateral wall capable of allowing the processed liquid medium to pass through. This arrangement makes it possible to ensure good contact between the nutritive medium and the yeast adhering to the filling components 203c placed in the volume comprised between the lateral wall of the cartridge and its two stoppers; this filling can be, as known in the state of the art, constituted of any appropriate material, for example the materials described in FIGS. 3 and 4 of this patent application. In this embodiment, the cartridge 203 is placed inside a vinification tank 204.

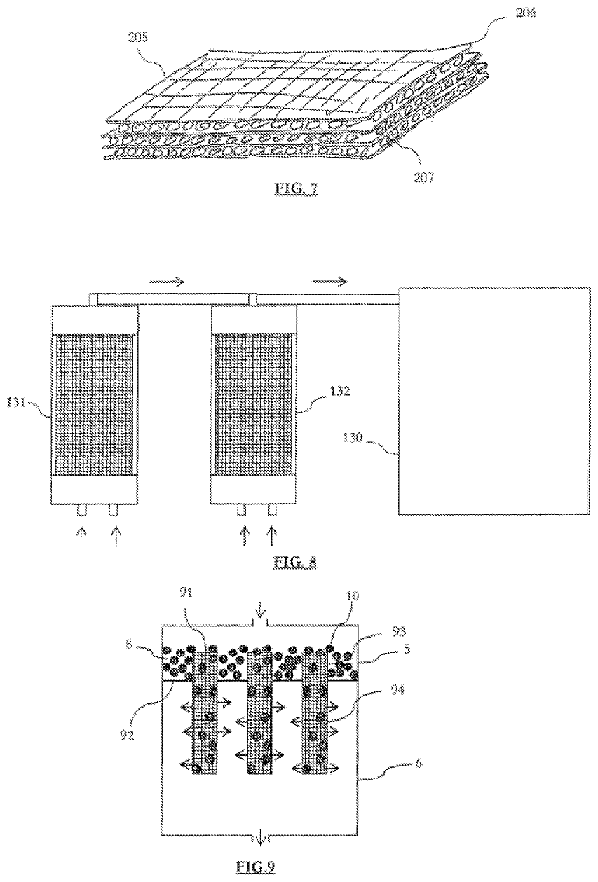

FIG. 7 represents, in perspective, a stack 205 of metallic cloths constituting flat grids. These superimposed metallic cloths hold fractional media 207 between them, which are caught between the parallel grids 206. As stated for the embodiment in FIG. 6, materials usable for the structures according to FIG. 7, are all of the materials known in the state of the art relative to the adhesion of microorganisms.

In FIG. 9, cartridges 91 positioned vertically on a horizontal tray 92, arranged in a reactor according to the invention, are represented in perspective, but not to scale. The upper part 93 of the cartridge 91, which overflows in relation to the plane of the tray 92, is liquid impermeable. The tray 92 is water-resistant to the liquid, which makes it possible to implement a first fermentation of the nutritive medium by the fractional solid media 10 loaded with microorganisms, forming a bed on the tray. The nutritive medium coming from the bed having partially fermented, spills into the cartridge 91, to undergo there a second fermentation by the solid media it encloses. In this cartridge 91, the liquid having undergone the second fermentation exits peripherally at its lateral walls 94. Advantageously, the cartridges 91 can be detachable in order to be replaced or loaded with solid media outside of the reactor. A by-pass circulation can be specified, by means of a conduit which connects the compartment 6 and the compartment 5, for the liquid that has undergone the second fermentation (not represented).

1. Method of fermentation of a continuous supply flow of liquid nutritive medium using microorganisms comprising yeast or bacteria comprising the steps of:
1) aerobic multiplication of said microorganisms carried out using the continuous supply flow with which they are put into contact, and
2) said microorganisms thus multiplied during step 1) are used for fermentation of said nutritive medium and to supply, at output, a flow of fermented nutritive medium,
wherein step 1) comprises fixing by adhesion of at least a part of said microorganisms on at least one fractional solid support to constitute with said fractional solid support loaded with microorganisms a filtering barrier interposed between the continuous supply flow of nutritive medium and the output flow of fermented nutritive medium, wherein in order to constitute said filtering barrier, said continuous supply flow of nutritive medium passes on said fractional solid support loaded with microorganisms grouped inside one or more housings, to supply at output, peripherally, the fermented nutritive medium.

2. The method according to claim 1, wherein the microorganisms are alcoholic fermentation yeast.

3. The method according to claim 1, wherein the microorganisms are malo-lactic fermentation bacteria.

4. The method according to claim 1, wherein in step 1), fixing of the microorganisms on said fractional solid support is on a plurality of said fractional solid support.

5. The method according to claim 4, wherein said fractional solid support is made of wood, metal, sintered metal, a porous or non-porous plastic material, a porous organic material, a porous mineral material.

6. The method according to claim 5, wherein said fractional solid support comprises wires, strips, groups of strips and of wires, metallic helicoids and metallic grids.

7. The method according to claim 1, wherein said filtering barrier is constituted around a cylindrically shaped supply zone of nutritive medium, for which the output is performed peripherally, said filtering barrier being constituted by a cylindrical crown of fractional solid support held externally by a sleeve, which constitutes the housing and, which allows the flow of the liquid nutritive medium to pass to constitute the output flow of the fermented nutritive medium.

8. The method according to claim 1, wherein the housing is a plurality of cartridges, enclosing the fractional solid support, in a substantially tubular shape placed on a tray, impermeable to liquid, placed in a passage between two compartments, said cartridge for which the upper part thereof, impermeable to the liquid, comprises an overflow in relation to a horizontal plane of the tray, and for which the lateral wall thereof is made of perforated material or of metallic grids.

9. The method according to claim 8, wherein height of the overflow of the upper part of each cartridge substantially corresponds to the thickness of the bed of fractional solid support on the tray which ensures the execution of a first fermentation.

10. A device for the implementation of a method according to claim 1, comprising two compartments, wherein one of the compartments is equipped with an extraction output for the extraction of a liquid constituted by a nutritive medium, which has already undergone the desired fermentation, wherein the other compartment is equipped with an input supply of said nutritive medium, not fermented or slightly fermented, and with a transit output towards the first compartment, a filtering barrier being arranged between the two compartments and enabling the transit of the nutritive medium between the two compartments, the liquid of one of the compartments containing, during operation, at least one fractional solid support on which microorganisms are adhered, which were introduced into said first compartment during a start-up phase, wherein the filtering barrier is constituted of said fractional solid support which are grouped inside one or more housings and which may be detachable, to provide at output, peripherally, the fermented nutritive medium.

11. The device according to claim 10, wherein, during the start-up phase, the microorganisms are introduced into the first compartment by recycling a fraction of the nutritive medium which has already partially undergone the desired fermentation.

12. The device according to claim 10, wherein the two compartments are arranged to the right of each other, wherein the transit of the flow of nutritive medium is executed by gravity and wherein the housing is a plurality of cartridges, enclosing the fractional solid support, in a substantially tubular form placed on a tray impermeable to the liquid, placed in the passage between the two compartments, a cartridge for which the upper part, impermeable to the liquid, comprises an overflow in relation to the horizontal plane of said tray, and for which the lateral wall is of a perforated material or of metallic grids.

13. The device according to claim 12, wherein height of the overflow of the upper part of each cartridge corresponds substantially to the thickness of the bed of fractional solid support.

14. The device according to claim 10, wherein said device comprises a first and a second unit of the same structure, for which the evacuation outputs are arranged in series to supply the input of a storage tank for fermented product, the first of the units providing fermentation by yeast and the second by bacteria.

15. The device according to claim 10, wherein the filtering barrier is an accumulation in cylindrical crown of fractional solid support held, around a cylindrical supply volume of the nutritive medium, by a sleeve which constitutes the housing, and which allows the output flow of the fermented nutritive medium to pass.

16. The device according to claim 15, wherein the second compartment is a closed volume, defined by a fabric or a permeable perforated material, and supplied by a conduit which brings to it microorganisms, oxygenated gas and the liquid nutritive medium, partially fermented or not, this second compartment enclosing the fractional solid support onto which the microorganisms adhere, wherein the first compartment is a housing filled by the fermented liquid nutritive medium produced then ejected from the second compartment by the liquid circulation that crosses it, to supply an external storage tank.

17. The device according to claim 16, wherein the housing, which constitutes the first compartment, is of one piece with the second compartment and its conduit in order to be placed in a storage tank as a monobloc assembly constituting a cartridge.

18. The device according to claim 17, wherein the conduit of the second compartment is equipped with piping which, when its opening is plunged into the storage tank to which it is connected, enables a partial recirculation of the liquid contained in said storage tank.

19. The device according to claim 17, wherein the second compartment is a component containing at least one metallic grid, of which threads form media for the culturing of microorganisms.

20. The device according to claim 19, wherein the component comprises a plurality of grids, of which threads are close to each other to improve the efficiency of the fermentation, wherein said grids are planar and parallel, or rolled cylindrically, wherein the component is equipped with sleeves at the ends, which hold the grids between them and which ensure the input and output of the liquid nutritive medium.
